(19) United States
(12) Patent Application Publication
(10) Pub. No.: US 2026/0032414 A1
(43) Pub. Date: Jan. 29, 2026

(54) SIDELINK RELAY TERMINAL, CONTROL METHOD OF SIDELINK RELAY TERMINAL, STORAGE MEDIUM STORING PROGRAM OF SIDELINK RELAY TERMINAL

(71) Applicant: CANON KABUSHIKI KAISHA, Tokyo (JP)

(72) Inventor: KOHTARO KOIKE, Kanagawa (JP)

(21) Appl. No.: 19/349,811

(22) Filed: Oct. 3, 2025

Related U.S. Application Data
(63) Continuation of application No. PCT/JP2024/012950, filed on Mar. 29, 2024.

(30) Foreign Application Priority Data
Apr. 7, 2023 (JP) 2023-062928

(51) Int. Cl. H04W 8/00; H04W 8/22; H04W 92/18

(52) U.S. Cl. CPC H04W 8/005; H04W 8/22; H04W 92/18

(57) ABSTRACT

A Sidelink relay terminal having a 3GPP® Sidelink communication function includes a Discovery reception unit, a relay request reception unit, a communication establishment unit, a determination unit configured to determine whether to execute the communication establishment unit based on an upper or lower limit value of a factor set by the Sidelink relay terminal, and a notification unit configured to notify a base station of information indicating that a request is rejected or approved and detailed cause information indicating the cause of the rejection or approval in a case where the determination unit determines to execute or not execute the communication establishment unit.

### CROSS-REFERENCE TO RELATED APPLICATIONS

This application is a Continuation of International Patent Application No. PCT/JP2024/012950, filed March 29, 2024, which claims the benefit of Japanese Patent Application No. 2023-062928, filed April 7, 2023, both of which are hereby incorporated by reference herein in their entirety.

### BACKGROUND

### Field of the Technology

The present disclosure relates to a Sidelink relay terminal, a control method of the Sidelink relay terminal, and a storage medium storing a program of the Sidelink relay terminal.

### Description of the Related Art

In recent years, 3rd Generation Partnership Project (3GPP®) has been developing 5G specifications. Among them, a standard specification referred to as Sidelink communication (hereinafter, “Sidelink”) is being developed. This specification realizes direct wireless communication between terminals referred to as User Equipment (UE) using an interface referred to as PC5 without going through a mobile communication network (core network). Specific examples of UE include smartphones, vehicles, and the like.

As a Sidelink communication operation, a process for switching from a direct path used by remote UE to communicate directly with a gNB (base station) to an indirect path used to communicate indirectly with a base station via relay UE is defined.

Following this process makes it possible to continue to communicate with the gNB via the relay UE even in a case where, for example, the remote UE is moved away from the gNB and communication using the direct path consequently becomes difficult. (Thereafter, a Sidelink relay terminal may also be referred to as relay UE.)

Further, Japanese Unexamined Patent Application Publication (Translation of PCT Application) No. 2018-535594 describes omitting unnecessary communication by performing a re-selection process without including relay UE having rejected a direct communication request message during relay UE re-selection by remote UE until timer expiration.

An example of a case where relay UE rejects a direct communication request message may be a case where communication traffic has increased due to an increased number of connections of the relay UE. Further, examples other than the above-described example include a case where the strength of a signal received from a gNB is low and a case where it becomes difficult for relay UE to operate due to low battery, overheating, or the like of the relay UE.

However, Japanese Unexamined Patent Application Publication (Translation of PCT Application) No. 2018-535594 only mentions that rejection of a direct communication request message is “not desired”, “not allowed”, or the like, and there is no specific description of a root cause or a detailed reason. Further, there is also no mention of relay UE rejecting a direct communication request message from a base station.

Since the conventional technology has no system for determining whether a communication apparatus that is a relay UE candidate is available as relay UE as described above, even when an indirect path is formed, it may not be possible to maintain the formed path. Further, in a case where a plurality of relay UE candidates is present, since there is no system that enables an apparatus to obtain a status of another apparatus, a base station simply selects relay UE based on signal strength, position, or the like, which may result in a failure to select suitable relay UE.

### SUMMARY

The present disclosure is based on at least one of the above-described issues. An aspect of the present disclosure is directed to providing a system that enables a base station to select suitable relay UE.

A Sidelink relay terminal includes a Discovery reception unit configured to receive a Discovery packet from a Sidelink remote terminal, a relay request reception unit configured to receive, from a base station, a request to function as a relay terminal, a first determination unit configured to determine whether the Sidelink relay terminal has a communication capability to accept the request, based on a first parameter related to the communication capability of the Sidelink relay terminal, a second determination unit configured to determine whether a determination criterion related to a predetermined parameter that is different from the first parameter and managed by the terminal is satisfied, a communication establishment unit configured to operate as a relay terminal in response to the request in a case where the first determination unit determines that the Sidelink relay terminal has the communication capability to accept the request and the second determination unit determines that the determination criterion is satisfied, and a notification unit configured to notify the base station of supplemental information about availability as a relay terminal that is generated based on the determination criterion, either before or after the request is received by the relay request reception unit.

Features of the present disclosure will become apparent from the following description of embodiments with reference to the attached drawings.

### BRIEF DESCRIPTION OF THE DRAWINGS

FIG. 1 is an example of a system overview diagram according to the present embodiment.

FIG. 2 is a block diagram illustrating an example of a functional configuration of a Sidelink relay terminal as a communication apparatus according to the present embodiment.

FIG. 3 is an example of a sequence diagram of a system according to a first embodiment.

FIG. 4 is an example of a frame structure diagram illustrating an RRC Connection re-establishment Request according to the first embodiment.

FIG. 5 is an example of a flowchart diagram of remote UE according to the first embodiment.

FIG. 6 is an example of a flowchart diagram of relay UE according to the first embodiment.

FIG. 7 is an example of a flowchart diagram of a base station according to the first embodiment.

FIG. 8 is an example of a sequence diagram of a system according to a second embodiment.

FIG. 9 is an example of a flowchart diagram of remote UE according to the second embodiment.

FIG. 10 is an example of a flowchart diagram of relay UE according to the second embodiment.

FIG. 11 is an example of a flowchart diagram of a base station according to the second embodiment.

FIG. 12 is an example of a sequence diagram of a system according to a third embodiment.

FIG. 13 is an example of a frame structure diagram of an RRC Not Recommended As Relay UE according to the third embodiment.

FIG. 14 is an example of a flowchart diagram of relay UE according to the third embodiment.

FIG. 15 is an example of a flowchart diagram of a base station according to the third embodiment.

### DESCRIPTION OF THE EMBODIMENTS

Embodiments will be described in detail with reference to the attached drawings. It should be noted that the embodiments described below are not intended to limit the claimed disclosure. Although the embodiments describe a plurality of features, not all the features are necessarily essential to the invention, and any of the features may be combined as needed. Furthermore, the same or similar components are assigned the same reference numeral in the attached drawings, and redundant descriptions are omitted.

### First Embodiment

### System Configuration

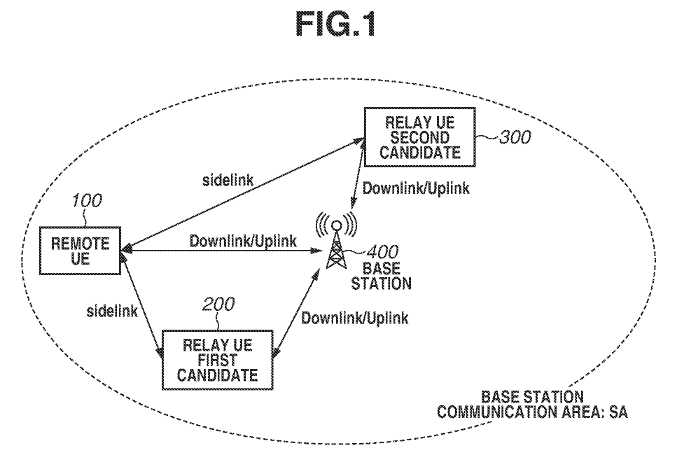

FIG. 1 is a diagram illustrating a configuration example of a system according to a first embodiment. In FIG. 1, remote UE 100, a relay UE first candidate 200, which may operate as relay UE of the remote UE 100, a relay UE second candidate 300, which may operate as relay UE of the remote UE 100, and a base station 400 are included. The base station 400 has a base station communication area SA, and UE can communicate with the base station if it is located within the base station communication area SA. The remote UE 100, the relay UE first candidate 200, and the relay UE second candidate 300 are all located within the base station communication area SA. Sidelink communication is performed between UE and UE, and Uplink/Downlink communication is performed between UE and the base station 400.

### Functional Configuration of Apparatus

Next, an example of a functional configuration of a Sidelink relay terminal as a communication apparatus according to the present embodiment will be described. It should be noted that configurations of functional blocks described below are merely examples.

Some or all of functional blocks described below may be replaced with another functional block configured to perform a similar function, and some of the functional blocks may be omitted, or another functional block may be added. Further, a single functional block described below may be divided into a plurality of functional blocks, or a plurality of functional blocks may be integrated into a single functional block.

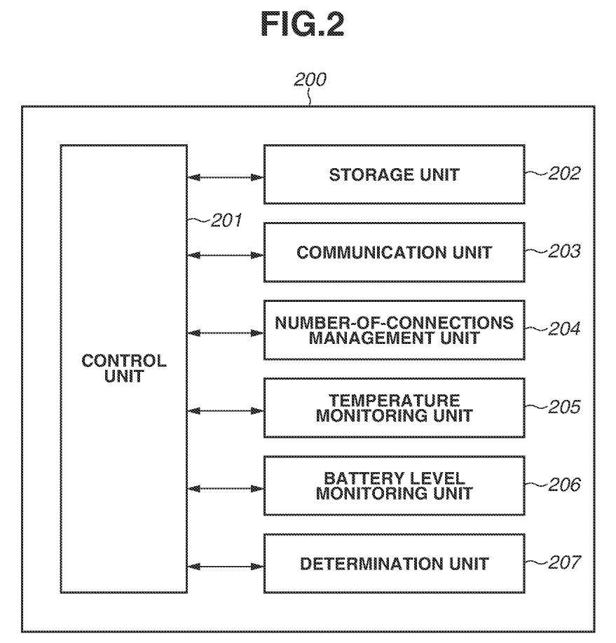

FIG. 2 is a block diagram illustrating an example of a functional configuration of a Sidelink relay terminal as a communication apparatus according to the present embodiment. The relay UE first candidate 200 is described herein to describe a communication apparatus according to the present embodiment.

In FIG. 2, a control unit 201 controls each unit of the relay UE first candidate 200 based on an input signal or a program described below. It should be noted that instead of the control unit 201 controlling the entire apparatus, a plurality of pieces of hardware may control the entire apparatus by distributing the processing across the plurality of pieces of hardware. The control unit 201 corresponds to a communication establishment unit.

The control unit 201 includes, for example, one or more processors, such as a CPU or an MPU, and controls the entire communication apparatus by executing a control program loaded into a RAM that is a storage unit 202. It should be noted that each process performed by the control unit 201 in a flowchart described below can also be realized using various hardware circuits. The various hardware circuits include an Application Specific Integrated Circuit (ASIC), a Field Programmable Gate Array (FPGA), and the like. Further, a process illustrated in a flowchart described below can also be realized by a hardware circuit and a processor, such as a CPU or an MPU, configured to collaborate with each other.

The storage unit 202 stores a control program executed by the control unit 201, information related to communication, a parameter value for determining whether UE is available as relay UE, and the like. Various operations described below are performed by the control unit 201 by executing a control program stored in the storage unit 202. The storage unit 202 may include a main storage unit and an auxiliary storage unit. The main storage unit is, for example, a Read Only Memory (ROM), a Random Access Memory (RAM), or the like. The main storage unit may store or temporarily store an Operating System (OS), which is basic software executed by the control unit 201, a program such as application software, data, and the like. The auxiliary storage unit is, for example, a Hard Disk Drive (HDD), a Solid State Drive (SSD), or the like and may store data related to application software and the like. For example, a control program stored in a non-volatile storage area is loaded into the Random Access Memory (RAM) and executed by a processor of the control unit 201. The control unit 201 and the storage unit 202 may function as a so-called computer as described above.

The storage unit 202 may include a recording medium configured to store a predetermined program. A program stored in this recording medium may be installed via a drive apparatus or the like, and the installed predetermined program may be configured to be executed by the control unit 201. Various types of recording media may be used as the recording medium. For example, the recording medium may be a recording medium configured to record information optically, electrically, or magnetically, such as a Compact Disc (CD)-ROM, a flexible disk, or a magneto-optical disk. Further, the recording medium may be a semiconductor memory configured to record information electrically, such as a ROM or a flash memory. It should be noted that recording media do not include a carrier wave.

A communication unit 203 is an interface for communicating with an external apparatus. Specific examples include Sidelink communication in accordance with 3GPP standards and Uplink/Downlink communication. Further, in a case where communication from an external apparatus is received, its signal power can also be acquired, and the acquired signal power is notified to the control unit 201. The communication unit 203 corresponds to a Discovery reception unit, a relay request reception unit, and a notification unit.

A number-of-connections management unit 204 manages the number of devices (mainly remote UE) to which its own UE is connected. In response to an inquiry about the number of connections from the control unit 201, the number of connections at the time of the inquiry is notified to the control unit 201.

A temperature monitoring unit 205 monitors the temperature of its own UE. In response to an inquiry about the temperature from the control unit 201, the temperature at the time of the inquiry and/or the temperature before and/or after the time of the inquiry is notified to the control unit 201.

A battery level monitoring unit 206 monitors the battery level of its own UE. In response to an inquiry about the battery level from the control unit 201, the battery level at the time of the inquiry and/or the battery level before and/or after the time of the inquiry is notified to the control unit 201.

A determination unit 207 determines whether the UE is capable of operating using an operation parameter (such as an operating frequency) specified in an RRC Reconfiguration from another apparatus. Furthermore, the determination unit 207 also determines whether its own UE is available as relay UE based on another determination criterion different from the determination of whether the UE is capable of operating using the operation parameter received from the above-described apparatus. Specifically, the determination unit 207 determines whether the UE is available as relay UE based on a determination criterion related to a predetermined parameter specific to the terminal (its own UE). In the present embodiment, the terminal-specific predetermined parameter is a parameter that is managed by the terminal (its own UE) and different from a parameter for identifying the capability of the UE to operate as relay UE. The terminal-specific predetermined parameter can be related to the status of the UE. It should be noted that the determination criterion is a determination criterion that may yield a different determination result for each terminal due to a predetermined parameter value that may differ for each terminal. Further, the determination criterion may be the same or differ between a Sidelink relay terminal and another Sidelink relay terminal. It should be noted that the determination unit 207 corresponds to a determination unit.

In the present embodiment, the predetermined parameter may include the number of connected devices (hereinafter, also referred to as “the number of connections”), signal power, battery level, temperature of its own terminal (its own device), or any combination thereof. Further, the determination criterion may be defined by a threshold such as an upper or lower limit value with respect to the value of the predetermined parameter. In a case where the control unit 201 notifies the determination unit 207 of the number of connections, signal power of communication from the base station 400, temperature of its own UE, or battery level, the determination unit 207 checks whether the notified value is within the threshold value. In a case where the notified value is within the threshold value, the determination unit 207 notifies the control unit 201 that the UE is available as relay UE. On the other hand, in a case where the notified value is not within the threshold value, the determination unit 207 notifies the control unit 201 that the UE is not available as relay UE, together with information (hereinafter, also referred to as “detailed cause information”) indicating the cause thereof.

The detailed cause information does not have to be information that explicitly indicates the cause and may be information from which the cause can be identified. For example, in a case where the cause is that “the temperature of its own terminal has exceeded the threshold”, the detailed cause information may be information that directly or indirectly indicates that “the temperature of its own terminal has exceeded the threshold”. In the latter case, for example, the detailed cause information may be information that indicates the temperature of the terminal and the threshold (or determination criterion).

An example of a block diagram illustrating an example of a functional configuration of the communication apparatus according to the present embodiment has been described. It should be noted that while the relay UE first candidate 200 is described in the present embodiment, the remote UE 100, the relay UE second candidate 300, and the base station 400 may have similar configurations. For example, reference numerals 101, 301, and 401 are assigned to control units of the remote UE 100, the relay UE second candidate 300, and the base station 400, respectively. Other blocks (functional units) such as communication units are also assigned reference numerals similarly.

### Process Example

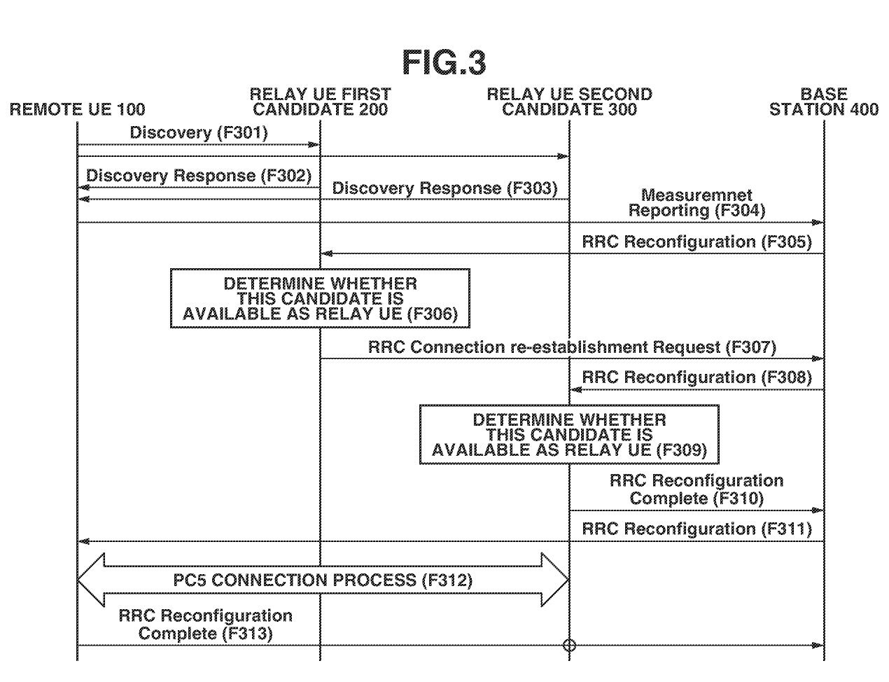

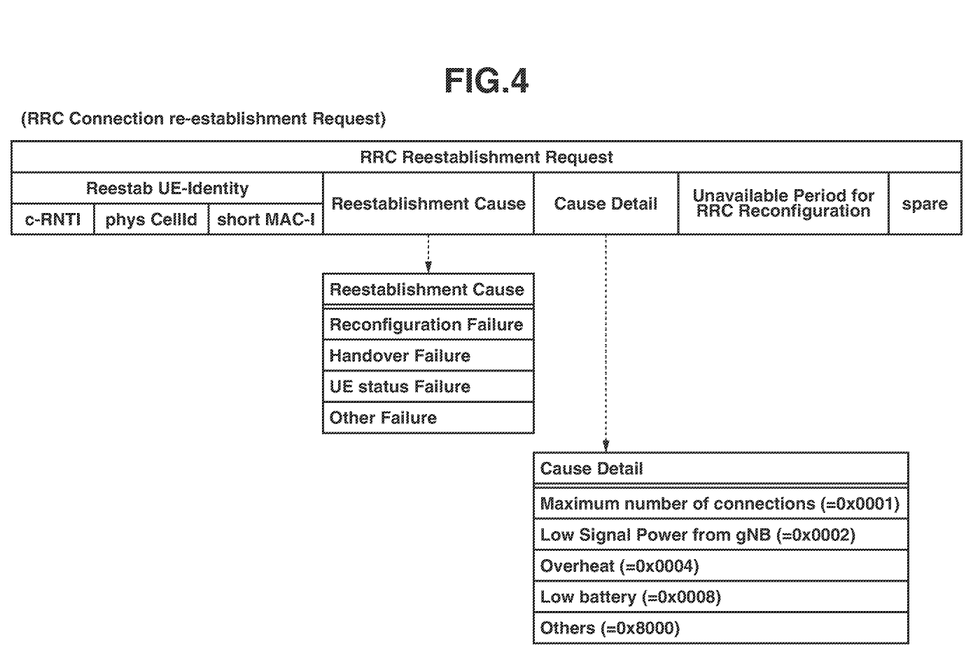

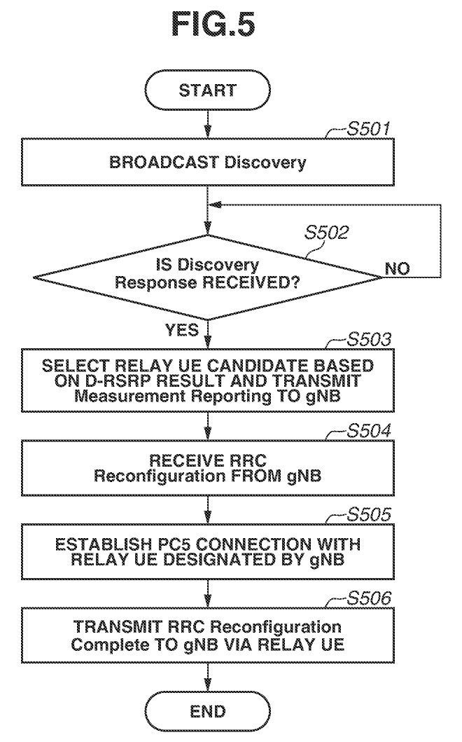

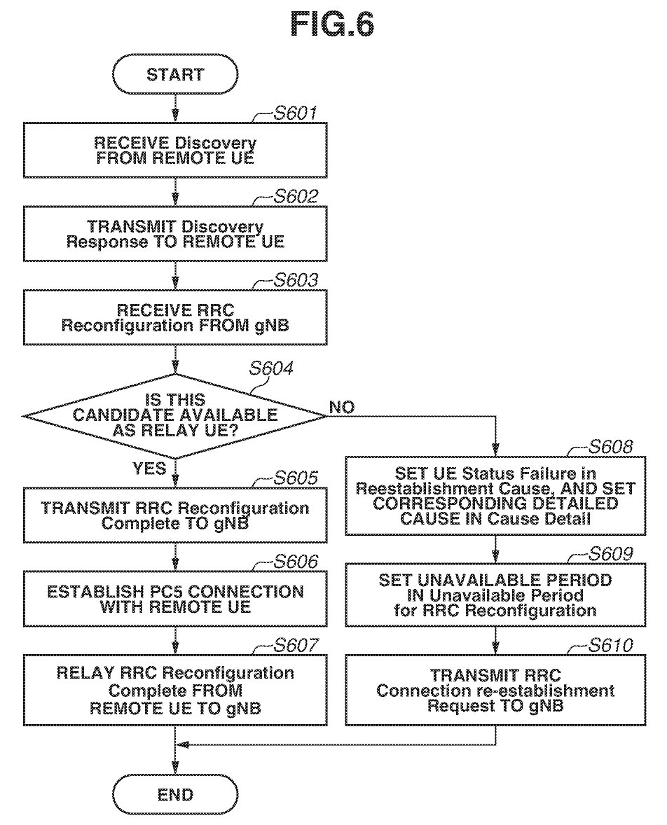

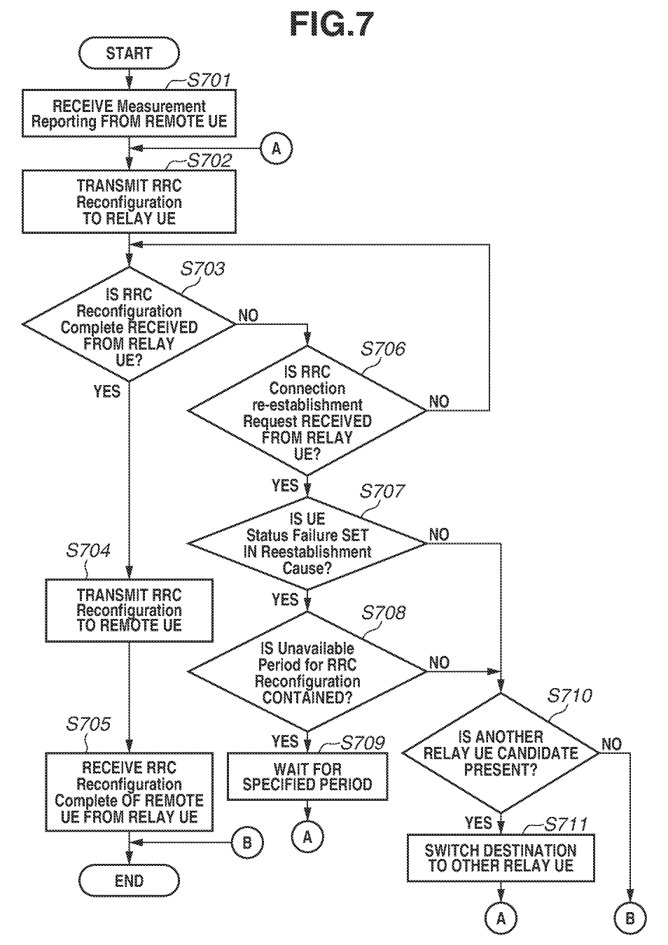

An example of operations according to the present embodiment will be described with reference to an example of an operation sequence illustrated in FIG. 3, an example of a frame structure of an RRC Connection re-establishment illustrated in FIG. 4, and examples of flowcharts illustrated in FIG. 5, FIG. 6, and FIG. 7.

FIG. 3 is an example of a sequence diagram in a case where the relay UE first candidate 200 according to the present embodiment is not available as relay UE when an RRC Reconfiguration is received from the base station 400.

The remote UE 100 broadcasts a Discovery via a communication unit 103 to search for a nearby device (F301). The relay UE first candidate 200 transmits a Discovery response to the remote UE 100 via the communication unit 203 (F302). The relay UE second candidate 300 also transmits a Discovery response to the remote UE 100 via a communication unit 303 (F303).

The remote UE 100 transmits a Measurement Reporting to the base station 400 via the communication unit 103 (F304). This packet contains an identifier of the relay UE first candidate 200, an identifier of the relay UE second candidate 300, signal power of each Discovery response, and the like. In the present embodiment, the signal power of the relay UE first candidate 200 is higher than the signal power of the relay UE second candidate 300.

The base station 400 transmits an RRC Reconfiguration to the relay UE first candidate 200 via a communication unit 403 based on the Measurement Reporting received from the remote UE 100 (F305). The RRC Reconfiguration contains an identifier of the remote UE 100, a configuration of Radio Link Control layer channels during PC5 relay communication, and the like.

The relay UE first candidate 200 receives the RRC Reconfiguration from the base station 400, and the control unit 201 acquires the signal power of the RRC Reconfiguration received from the base station 400 via the communication unit 203. Next, the control unit 201 acquires the number of currently connected devices from the number-of-connections management unit 204. Furthermore, the control unit 201 acquires the current temperature of its own terminal from the temperature monitoring unit 205. Lastly, the control unit 201 acquires the current battery level from the battery level monitoring unit 206. The control unit 201 acquires the information described above and provides notification to prompt the determination unit 207 to determine whether its own terminal is available as relay UE. First, as a first determination process, the determination unit 207 determines whether its own UE is available using the operation parameter specified in the RRC Reconfiguration. In a case where the determination unit 207 determines that its own UE is not available using the operation parameter specified in the RRC Reconfiguration, the determination unit 207 notifies the control unit 201 of the unavailability and detailed cause information indicating that the unavailability is caused by failing to satisfy a reconfiguration condition. In a case where the determination unit 207 determines that its own UE is available using the operation parameter specified in the RRC Reconfiguration, the determination unit 207 performs a second determination process to determine whether its own UE is available as relay UE based on another factor. The determination unit 207 checks each piece of information as a terminal-specific predetermined parameter acquired from the control unit 201 and an upper or lower limit value of each piece of information stored in the determination unit 207 and performs the second determination process to determine whether its own UE is available as relay UE (F306). Specific determination methods used in the second determination process are a method of determining whether the number of connections is less than the upper limit value, a method of determining whether the signal power of the base station 400 is greater than or equal to the lower limit value, a method of determining whether the temperature of the terminal is less than or equal to the upper limit value, and a method of determining whether the battery level is greater than or equal to the lower limit value. The determination unit 207 may be configured to determine that the UE is available as relay UE in a case where at least some of the conditions of the second determination process are satisfied. Further, the determination unit 207 may be configured to determine that the UE is available as relay UE in a case where all the conditions of the second determination process are satisfied. Specifically, even in a case where the first determination process determines that the UE is available using an operation parameter specified due to hardware of the apparatus or the like, if a condition of the second determination process performed based on other information is not satisfied, the determination unit 207 may determine that the UE is not available as relay UE.

FIG. 3 illustrates an example of a sequence in a case where the determination unit 207 determines that the relay UE first candidate 200 is not available as relay UE because the number of connections of the relay UE first candidate 200 is equal to the upper limit value. In this case, the control unit 201 is notified of the unavailability and the detailed cause information indicating that the cause of the unavailability is due to the upper limit of the number of connections. The detailed cause information is an example of supplemental information.

The control unit 201 transmits an RRC Connection re-establishment Request to the base station 400 via the communication unit 203 (F307). An example of a frame structure of the RRC Connection re-establishment Request will be described below with reference to FIG. 4.

Upon receiving the RRC Connection re-establishment Request from the relay UE first candidate 200 via the communication unit 403, the base station 400 switches the destination to the relay UE second candidate 300. Details of control performed before the switching will be described below with reference to FIG. 7. The base station 400 transmits an RRC Reconfiguration to the relay UE second candidate 300 via the communication unit 403 (F308), as in (F305).

In a case where the RRC Reconfiguration from the base station 400 is received by the relay UE second candidate 300 via the communication unit 303, the control unit 301 instructs a determination unit 307 to determine whether the relay UE second candidate 300 is available as relay UE (F309), as in (F306). The determination unit 307 determines that all the conditions described above in (F306) are satisfied, and notifies the control unit 301 that the relay UE second candidate 300 is available as relay UE.

The control unit 301 transmits an RRC Reconfiguration Complete to the base station 400 via the communication unit 303 (F310). Upon receiving the RRC Reconfiguration Complete from the relay UE second candidate 300 via the communication unit 403, the base station 400 determines to operate the relay UE second candidate 300 as relay UE of the remote UE 100. The base station 400 transmits an RRC Reconfiguration to the remote UE 100 via the communication unit 403 (F311). The RRC Reconfiguration in (F311) contains the identifier of the relay UE second candidate 300, a configuration of Radio Link Control layer channels during PC5 relay communication, and the like.

In a case where the RRC Reconfiguration from the base station 400 is received by the remote UE 100 via the communication unit 103, the control unit 101 performs a PC5 connection process with the relay UE second candidate 300 via the communication unit 103 (F312).

Upon completion of the PC5 connection process, the remote UE 100 transmits an RRC Reconfiguration Complete to the base station 400 via the communication unit 103 (F313). From this time, the remote UE 100 establishes an indirect path to the base station 400 using the relay UE second candidate 300 as relay UE and realizes communication with the base station 400.

An example of a sequence diagram in a case where the relay UE first candidate 200 according to the present embodiment is not available as relay UE when an RRC Reconfiguration is received from the base station has been described. At this time, the relay UE second candidate 300 operates as relay UE of the remote UE 100.

FIG. 4 is an example of a frame structure diagram illustrating an RRC Connection re-establishment Request according to the present embodiment.

While the frame structure of the RRC Connection re-establishment Request is defined by 3GPP, in order to realize the present embodiment, new information is added to the defined frame structure. Specifically, new information is added as the cause to a Reestablishment Cause, which is an existing parameter. Further, a Cause Detail and an Unavailable Period for RRC Reconfiguration, which are new parameters, are defined and added.

As information to be set in the Reestablishment Cause, 3GPP defines three causes, which are Reconfiguration Failure, Handover Failure, and Other Failure. The Reconfiguration Failure is set in a case where the UE is not compliant with the RRC Reconfiguration. It should be noted that being compliant or not compliant with the RRC Reconfiguration indicates that the relay UE can or cannot operate according to a setting of the RRC Reconfiguration. The Handover Failure is set in a case where T304, which is a 5G New Radio (NR) timer, expires. The Other Failure is set in other cases. In the present embodiment, “UE status Failure” is newly defined. The “UE status Failure” is set in a case where at least one of the conditions determined in (F306) is not satisfied.

Next, the detailed cause information (information that indicates a detailed cause of the failure to satisfy the conditions in F306) is set in the Cause Detail. A case where the number of connections reaches the upper limit is defined as 0x0001, a case where the signal power of the base station 400 is low is defined as 0x0002, a case where the temperature rises is defined as 0x0004, and a case where the battery is low is defined as 0x0008. A setting for a case where a plurality of factors is not satisfied may also be defined. Further, other factors (refer to others (= 0x8000) in FIG. 4) may also be defined.

Lastly, the Unavailable Period for RRC Reconfiguration indicates a period during which the UE is not available as relay UE although an RRC Reconfiguration is received. In a case where the period is not set, the UE may be excluded from the RRC Reconfiguration transmission target.

An example of the frame structure of the RRC Connection re-establishment Request according to the present embodiment has been described.

FIG. 5 is an example of a flowchart diagram illustrating operations of the remote UE 100 according to the present embodiment.

The remote UE 100 broadcasts a Discovery via the communication unit 103 to search for a relay UE candidate device (S501). After transmitting the Discovery, the remote UE 100 waits until a Discovery response is received from a nearby device (S502). In a case where a Discovery response is received via the communication unit 103, the control unit 101 can use the Discovery response in selecting a relay UE group. For example, the control unit 101 uses the result of measuring the Sidelink Discovery Reference Signal Received Power (SD-RSRP) of the Discovery response. Based on the measurement result, only a device from which a Discovery response is received with an SD-RSRP (signal power) greater than or equal to a predefined power value is set as a relay UE candidate. In the present embodiment, the relay UE first candidate 200 and the relay UE second candidate 300 are set as relay UE candidates. Once the relay UE candidates are set, a Measurement Reporting is transmitted to the base station 400 via the communication unit 103 (S503). Subsequently, an RRC Reconfiguration is received from the base station 400 via the communication unit 103 (S504). The identifier of the relay UE second candidate 300 and the like are acquired from the RRC Reconfiguration, and a PC5 connection is established with the relay UE second candidate 300 via the communication unit 103 (S505). Once the PC5 connection is established, an indirect path to the base station 400 is formed using the relay UE second candidate 300 as relay UE, and an RRC Reconfiguration Complete is transmitted to the base station 400 via the communication unit 103 (S506).

An example of a flowchart illustrating operations of the remote UE 100 according to the present embodiment has been described.

FIG. 6 is an example of a flowchart diagram illustrating operations of the relay UE first candidate 200 and the relay UE second candidate 300 according to the present embodiment. While only the operations of the relay UE first candidate 200 will be described, the relay UE second candidate 300 also performs similar operations.

The relay UE first candidate 200 receives a Discovery from the remote UE 100 via the communication unit 203 (S601). The relay UE first candidate 200 transmits a Discovery response to the remote UE 100 via the communication unit 203 (S602).

Subsequently, the relay UE first candidate 200 receives an RRC Reconfiguration from the base station 400 via the communication unit 203 (S603). The control unit 201 of the relay UE first candidate 200 notifies the determination unit 207 of an instruction including information necessary for determining whether the candidate is available as relay UE. The determination unit 207 determines whether the candidate is available as relay UE based on the information acquired from the control unit 201 (S604). In a case where the determination unit 207 determines that the candidate is available as relay UE, the determination unit 207 notifies the control unit 201 of the determination result. The control unit 201 transmits an RRC Reconfiguration Complete to the base station 400 via the communication unit 203 (S605).

In a case where a PC5 connection request is received from the remote UE 100 via the communication unit 203 after the RRC Reconfiguration Complete is transmitted, the relay UE first candidate 200 establishes a PC5 connection with the remote UE 100 (S606). Thereafter, the relay UE first candidate 200 operates as relay UE between the remote UE 100 and the base station 400. Accordingly, upon receiving an RRC Reconfiguration Complete from the remote UE 100, the relay UE first candidate 200 relays the RRC Reconfiguration Complete to the base station 400 (S607).

On the other hand, in a case where the determination unit 207 determines that the candidate is not available (hereinafter, also referred to as “unavailable”) as relay UE (“NO” in S604), the determination unit 207 notifies the control unit 201 of the determination result and the cause. In the present embodiment, the candidate is determined as not being available because the number of connections has reached the upper limit. The control unit 201 sets the UE status Failure because of the unavailability and sets the Maximum number of connections in the Cause Detail (S608). Furthermore, the control unit 201 sets an unavailable period in the period in the Unavailable Period for RRC Reconfiguration (S609). The control unit 201 notifies the communication unit 203 of the values set in (S608) and (S609), and the communication unit 203 transmits an RRC Connection re-establishment Request to the base station 400 (S610).

An example of a flowchart illustrating operations of the relay UE first candidate 200 and the relay UE second candidate 300 according to the present embodiment has been described.

FIG. 7 is an example of a flowchart diagram illustrating operations of the base station 400 according to the present embodiment.

The base station 400 receives a Measurement Reporting from the remote UE 100 via the communication unit 403 (S701). The control unit 401 checks a relay UE candidate group in the Measurement Reporting. At this time, the base station 400 transmits an RRC Reconfiguration to the relay UE first candidate 200, from which a Discovery response with the highest signal power is received by the remote UE 100, via the communication unit 403 (S702). The base station 400 waits for an RRC Reconfiguration Complete from the relay UE first candidate 200 via the communication unit 403 (S703). In a case where an RRC Reconfiguration Complete is received from the relay UE first candidate 200 via the communication unit 403, the base station 400 transmits an RRC Reconfiguration to the remote UE 100 via the communication unit 403 (S704). The RRC Reconfiguration contains the identifier of the relay UE first candidate 200 and the like. After transmitting the RRC Reconfiguration, the base station 400 receives an RRC Reconfiguration Complete of the remote UE 100 from the relay UE first candidate 200 via the communication unit 403 (S705).

While waiting for an RRC Reconfiguration Complete from the relay UE first candidate 200 (S703), the base station 400 also waits to receive an RRC Connection re-establishment Request (S706).

In a case where an RRC Connection re-establishment Request is received by the base station 400, the control unit 401 checks whether the UE status Failure is set in the Reestablishment Cause (S707). In a case where the UE status Failure is set, the control unit 401 checks whether the Unavailable Period for RRC Reconfiguration is contained (S708). In a case where the Unavailable Period for RRC Reconfiguration is contained, the control unit 401 waits for the set period (S709). After waiting for the set period, the base station 400 returns to (S702) and transmits an RRC Reconfiguration again to the relay UE first candidate 200 via the communication unit 403. Next, the base station 400 waits for an RRC Reconfiguration Complete from the relay UE first candidate 200 (S703).

In a case where the cause is something other than the UE status Failure (“NO” in S707), the presence of another relay UE candidate from the acquired relay UE candidate group is checked (S710). In a case where the Unavailable Period for RRC Reconfiguration is not contained (“NO” in S708), the presence of another relay UE candidate in the relay UE candidate group is also checked (S710). In a case where another relay UE candidate is present, the destination is switched to the other relay UE candidate (S711). In the present embodiment, the other relay UE candidate corresponds to the relay UE second candidate 300. Subsequently, the base station 400 returns to S702 and waits for an RRC Reconfiguration Complete from the relay UE second candidate 300 (S703).

In a case where another relay UE candidate is not present (“NO” in S710), the base station 400 terminates the process. It should be noted that in a modified example, the processing may proceed to S710 even in a case where the determination result is “YES” in S708. In this case, the processing may proceed to S709 in a case where the determination result is “NO” in S710. This is particularly suitable for a case where the period related to the Unavailable Period for RRC Reconfiguration is relatively long.

An example of a flowchart illustrating operations of the base station 400 according to the present embodiment has been described.

As described above, according to the present embodiment, in a case where the relay UE first candidate 200 receives an RRC Reconfiguration from the base station 400, the determination of whether the UE is available as relay UE is performed based on a factor other than compliance with the RRC Reconfiguration. In addition, the base station 400 is notified that the UE is not available as relay UE and is also notified of the cause of the unavailability. This makes it possible to prevent the relay UE first candidate 200 from operating as relay UE of the remote UE 100 in a case where the relay UE first candidate 200 complies with the RRC Reconfiguration but is not available as relay UE due to a factor other than the compliance. It should be noted that the factor other than the compliance is, for example, the temperature of its own terminal or the like, as described above. Furthermore, it becomes possible for the base station 400 to perform processing based on the cause of the unavailability of the relay UE first candidate 200.

While the Maximum number of connections is set in the Cause Detail in the present embodiment, a similar effect is also produced by other factors illustrated in FIG. 4.

Further, while the relay UE first candidate 200 always sets the Unavailable Period for RRC Reconfiguration in (S609) in FIG. 6, this setting may not be necessary depending on the factor. For example, in the case of Low Signal Power from gNB, it may not be possible to determine when the signal power will reach or exceed a predefined value.

### Second Embodiment

In the present embodiment, an example of a case where the relay UE first candidate 200 is determined as being unavailable as relay UE when establishing a PC5 connection with the remote UE 100 will be described.

A system configuration according to the present embodiment is similar to that illustrated in FIG. 1, and a frame structure of an RRC Connection re-establishment Request according to the present embodiment is similar to that illustrated in FIG. 4, so that descriptions are omitted.

### Process Example

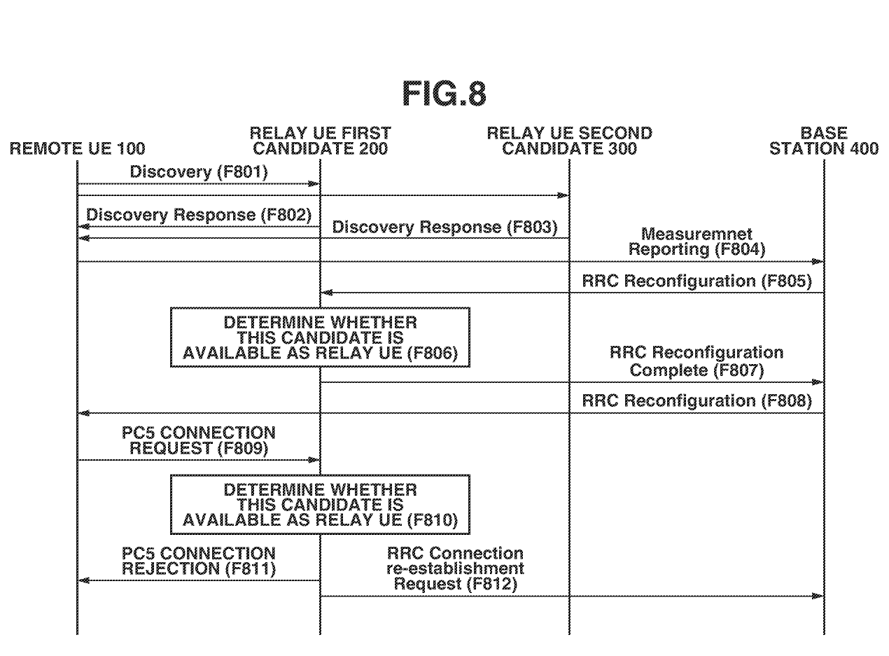

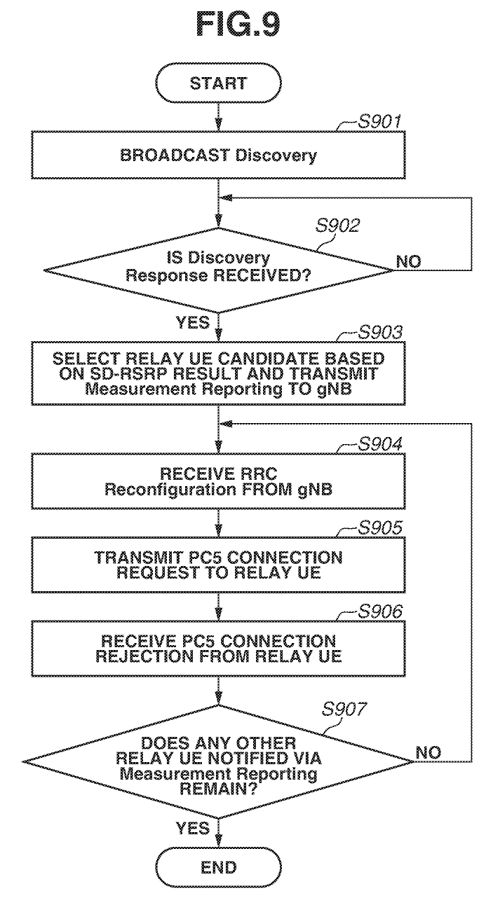

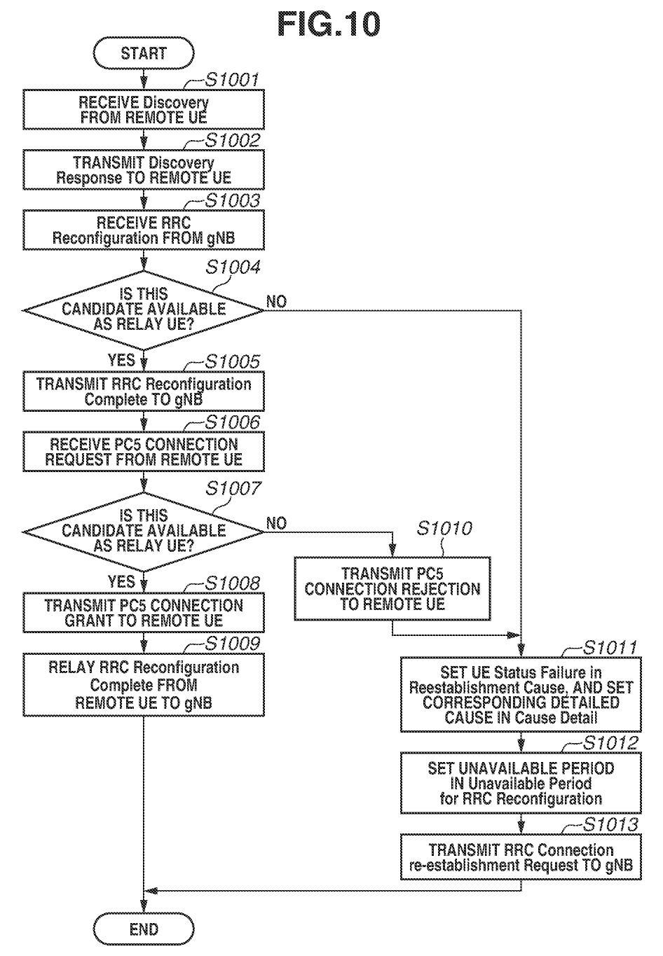

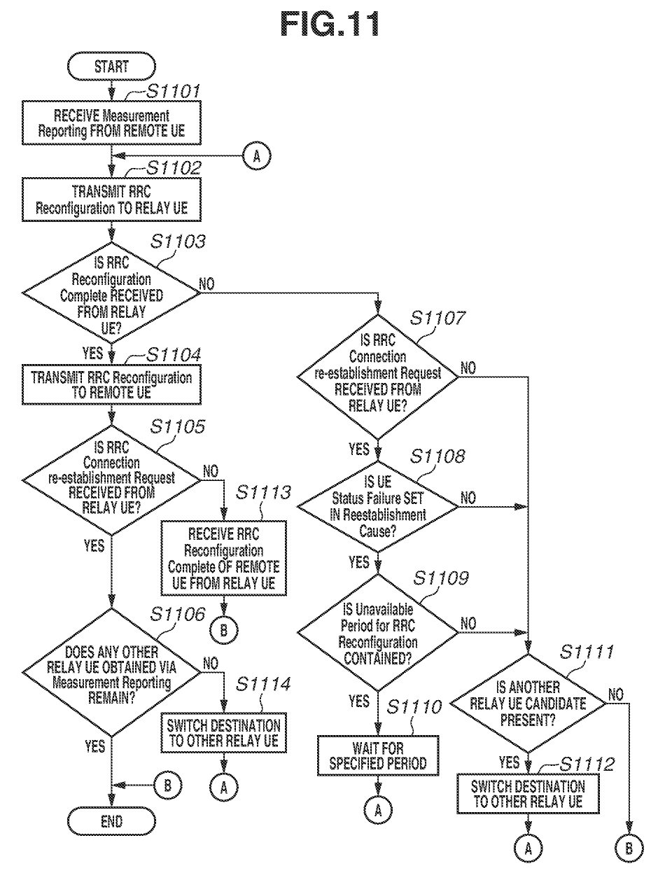

An example of operations according to the present embodiment will be described with reference to an example of an operation sequence illustrated in FIG. 8 and examples of flowcharts illustrated in FIG. 9, FIG. 10, and FIG. 11.

FIG. 8 is a sequence diagram illustrating an example of a case where the relay UE first candidate 200 according to the present embodiment is determined as being unavailable as relay UE when establishing a PC5 connection with the remote UE 100.

(F801) to (F806) are similar to the operations in (F301) to (F306), so that redundant descriptions are omitted.

In (F806), the determination unit 207 of the relay UE first candidate 200 determines that the relay UE first candidate 200 is available as relay UE, and notifies this determination result to the control unit 201. The control unit 201 transmits an RRC Reconfiguration Complete to the base station 400 via the communication unit 203 (F807). The base station 400 receives the RRC Reconfiguration Complete via the communication unit 403 and transmits an RRC Reconfiguration to the remote UE 100 (F808). This RRC Reconfiguration contains the identifier of the relay UE first candidate 200 and the like.

After receiving the RRC Reconfiguration via the communication unit 103 and checking the identifier of the relay UE first candidate 200 and the like, the remote UE 100 transmits a PC5 connection request to the relay UE first candidate 200 (F809).

Upon receiving the PC5 connection request via the communication unit 203, the control unit 201 of the relay UE first candidate 200 instructs the determination unit 207 to determine whether the relay UE first candidate 200 is available as relay UE. The determination unit 207 determines whether the candidate is available as relay UE (F810), as in (F806). Unlike the availability determination result in (F806), the determination unit 207 determines that the candidate is unavailable. An example of a case where the candidate is determined as being unavailable is a case where the battery level received from the battery level monitoring unit 206 is less than or equal to a threshold. In this case, the determination unit 207 notifies the control unit 201 that the candidate is unavailable as relay UE, together with detailed cause information indicating that the unavailability is due to low battery. As a result, the control unit 201 transmits, in response to the PC5 connection request, a response indicating that the PC5 connection request is rejected to the remote UE 100 via the communication unit 203 (F811). Following the operation in (F811), the control unit 201 transmits an RRC Connection re-establishment Request to the base station 400 via the communication unit 203 (F812). In a case where another relay UE candidate remains at the time of (F812), the base station 400 performs a process similar to the operations starting from (F308), so that redundant descriptions are omitted herein. In a case where no other relay UE candidate remains at the time of (F812), a process similar to the operations starting from (F301) is performed, so that redundant descriptions are omitted herein.

A diagram illustrating an example of a sequence in a case where the relay UE first candidate 200 according to the present embodiment is determined as being unavailable as relay UE when establishing a PC5 connection with the remote UE 100 has been described.

FIG. 9 is an example of a flowchart diagram illustrating operations of the remote UE 100 according to the present embodiment.

The remote UE 100 broadcasts a Discovery via the communication unit 103 to search for a relay UE candidate device (S901). After transmitting the Discovery, the remote UE 100 waits to receive a Discovery response from a nearby device (S902). In a case where a Discovery response is received, the control unit 101 uses, for example, the Discovery response in selecting a relay UE group. For example, the control unit 101 uses the result of measuring the SD-RSRP (Sidelink Discovery Reference Signal Received Power) of the Discovery response. Based on the measurement result, only a device from which a Discovery response is received with an SD-RSRP (signal power) greater than or equal to a predefined power value is set as a relay UE candidate. In the present embodiment, the relay UE first candidate 200 and the relay UE second candidate 300 are set as relay UE candidates. Once the relay UE candidates are set, a Measurement Reporting is transmitted to the base station 400 via the communication unit 103 (S903). Subsequently, the remote UE 100 receives an RRC Reconfiguration from the base station 400 via the communication unit 103 (S904).

The remote UE 100 acquires the identifier of the relay UE first candidate 200 and the like from the RRC Reconfiguration and transmits a connection request to establish a PC5 connection with the relay UE first candidate 200 via the communication unit 103 (S905). The remote UE 100 receives a connection rejection response from the relay UE first candidate 200 via the communication unit 103 (S906).

In a case where the remote UE 100 receives a connection rejection response via the communication unit 103, the control unit 101 checks whether another relay UE candidate remains in the relay UE candidate group in the Measurement Reporting transmitted in (S903) (S907). In a case where another relay UE candidate remains, the processing returns to (S904) to wait for an RRC Reconfiguration from the base station 400. In a case where no other relay UE candidate remains, the process is terminated.

An example of a flowchart illustrating operations of the remote UE 100 according to the present embodiment has been described.

FIG. 10 is an example of a flowchart diagram illustrating operations of the relay UE first candidate 200 and the relay UE second candidate 300 according to the present embodiment. While only the operations of the relay UE first candidate 200 will be described, the relay UE second candidate 300 also performs similar operations.

The relay UE first candidate 200 receives a Discovery from the remote UE 100 via the communication unit 203 (S1001). The relay UE first candidate 200 transmits a Discovery response to the remote UE 100 via the communication unit 203 (S1002).

Subsequently, the relay UE first candidate 200 receives an RRC Reconfiguration from the base station 400 via the communication unit 203 (S1003). The control unit 201 of the relay UE first candidate 200 notifies the determination unit 207 of an instruction including information necessary for determining whether the candidate is available as relay UE. The determination unit 207 determines whether the candidate is available as relay UE based on the information acquired from the control unit 201 (S1004). In a case where the determination unit 207 determines that the candidate is available as relay UE (“YES” in S1004), the determination unit 207 notifies this determination result to the control unit 201. The control unit 201 transmits an RRC Reconfiguration Complete to the base station 400 via the communication unit 203 (S1005).

After the RRC Reconfiguration Complete is transmitted, the relay UE first candidate 200 receives a PC5 connection request from the remote UE 100 via the communication unit 203 (S1006). Upon receiving the PC5 connection request, the control unit 201 of the relay UE first candidate 200 notifies the determination unit 207 of an instruction including information necessary for determining whether the candidate is available as relay UE. The determination unit 207 determines whether the candidate is available as relay UE based on the information acquired from the control unit 201 (S1007). In a case where the determination unit 207 determines that the candidate is available as relay UE, the determination unit 207 notifies the control unit 201 of this determination result. The control unit 201 transmits a PC5 connection request grant to the remote UE 100 via the communication unit 203 (S1008). Thereafter, the relay UE first candidate 200 operates as relay UE between the remote UE 100 and the base station 400. The relay UE first candidate 200 receives an RRC Reconfiguration Complete from the remote UE 100 via the communication unit 203 and relays the RRC Reconfiguration Complete to the base station 400 (S1009).

On the other hand, in a case where the determination unit 207 determines that the candidate is unavailable as relay UE (“NO” in S1007), the control unit 201 is notified of detailed cause information. In the present embodiment, a case where the candidate is determined as being unavailable due to low battery will be described. The control unit 201 transmits a PC5 connection request rejection to the remote UE 100 via the communication unit 203 (S1010). The control unit 201 sets the UE status Failure because of the unavailability and sets the Low battery in the Cause Detail (S1011). Furthermore, the control unit 201 sets an unavailable period in the Unavailable Period for RRC Reconfiguration (S1012). The control unit 201 notifies the communication unit 203 of the values set in (S1011) and (S1012), and the communication unit 203 transmits an RRC Connection re-establishment Request to the base station 400 (S1013). An example of a flowchart illustrating operations of the relay UE first candidate 200 and the relay UE second candidate 300 according to the present embodiment has been described.

It should be noted that in a modified example, only the determination of compliance with the RRC Reconfiguration may be performed in S1004, considering that the determination in S1007 is subsequently performed.

FIG. 11 is an example of a flowchart diagram illustrating operations of the base station 400 according to the present embodiment.

The base station 400 receives a Measurement Reporting from the remote UE 100 via the communication unit 403 (S1101). The control unit 401 checks a relay UE candidate group in the Measurement Reporting. At this time, the base station 400 transmits an RRC Reconfiguration to the relay UE first candidate 200, from which a Discovery response with the highest signal power is received by the remote UE 100, via the communication unit 403 (S1102). The base station 400 waits for an RRC Reconfiguration Complete from the relay UE first candidate 200 via the communication unit 403 (S1103).

In a case where an RRC Reconfiguration Complete is received from the relay UE first candidate 200, the base station 400 transmits an RRC Reconfiguration to the remote UE 100 via the communication unit 403 (S1104).

The base station 400 checks whether an RRC Connection re-establishment Request is received from the relay UE first candidate 200 via the communication unit 403 (S1105). In a case where an RRC Connection re-establishment Request is received, the base station 400 determines whether another relay UE candidate remains in the relay UE candidate group (S1106). It should be noted that the relay UE candidate group used at this time is acquired from the Measurement Reporting received in (S1101). In a case where no other relay UE candidate remains, the process is terminated.

In a case where no RRC Connection re-establishment Request is received (“NO” in S1105), the base station 400 performs processing in S1113. Specifically, the base station 400 receives an RRC Reconfiguration Complete of the remote UE 100 from the relay UE first candidate 200 (S1113).

As a result, an indirect path to the remote UE 100 is formed using the relay UE first candidate 200 as relay UE, and the process is terminated.

A case where the determination result is “YES” in S1105 although an RRC Reconfiguration Complete from the relay UE first candidate 200 is received (S1103) is as follows. In a case where another relay UE candidate remains in the relay UE candidate group acquired from the Measurement Reporting (“NO” in S1106), the control unit 401 instructs the communication unit 403 to switch the destination to the other relay UE candidate (S1114). After the destination is switched by the communication unit 403 (S1102), the process is resumed.

While waiting to receive an RRC Reconfiguration Complete from the relay UE first candidate 200, the base station 400 also waits to receive an RRC Connection re-establishment Request (S1107).

In a case where an RRC Connection re-establishment Request is received by the base station 400 via the communication unit 403, the control unit 401 performs processing in S1108. Specifically, the control unit 401 checks whether the UE status Failure is set in the Reestablishment Cause (S1108). In a case where the UE status Failure is set, the control unit 401 checks whether the Unavailable Period for RRC Reconfiguration is contained (S1109). In a case where the Unavailable Period for RRC Reconfiguration is contained, the control unit 401 waits for the set period (S1110). After waiting for the set period, the base station 400 returns to (S1102) and waits for an RRC Reconfiguration Complete from the relay UE first candidate 200.

In a case where the determination result is “NO” in any one of S1107, S1108, and S1109, the processing proceeds to step S1111. In this case, the presence of another relay UE candidate in the acquired relay UE candidate group is checked (S1111). The presence of another relay UE candidate in the acquired relay UE candidate group is also checked (S1111) in a case where no Unavailable Period for RRC Reconfiguration is contained (“NO” in S1109). In a case where another relay UE candidate is present (“YES” in S1111), the destination is switched to the other relay UE candidate (S1112). In the present embodiment, the relay UE second candidate 300 corresponds. Subsequently, the base station 400 returns to (S1102) and waits for an RRC Reconfiguration Complete from the relay UE second candidate 300.

On the other hand, in a case where no other relay UE candidate is present (“NO” in S1111), the base station 400 terminates the process.

An example of a flowchart illustrating operations of the base station 400 according to the present embodiment has been described.

As described above, according to the present embodiment, in a case where the relay UE first candidate 200 receives a PC5 connection request from the remote UE 100, the determination of whether the UE is available as relay UE is performed based on a factor other than compliance with the RRC Reconfiguration. In addition, the base station 400 is notified that the UE is not available as relay UE and is also notified of the cause of the unavailability.

Thus, even in a case where the relay UE first candidate 200 complies with the RRC Reconfiguration, the relay UE first candidate 200 can be determined as being unavailable as relay UE due to a factor other than the compliance, thereby preventing the relay UE first candidate 200 from operating as relay UE of the remote UE 100. Furthermore, it becomes possible for the base station 400 to perform processing based on the received detailed cause information.

Further, the present embodiment produces an effect similar to that produced by the first embodiment. In other words, even in a case where the Cause Detail is a cause other than those described in the present embodiment, or regardless of the presence or absence of the Unavailable Period for RRC Reconfiguration, the effect of the present embodiment does not change. It should be noted that the connection rejection message to the remote UE may be configured to include the unavailability as relay UE and the cause of the unavailability to also notify the remote UE of the unavailability and the cause of the unavailability.

### Third Embodiment

In the present embodiment, a case where the availability as relay UE is determined when the relay UE first candidate 200 receives a Discovery from the remote UE 100 will be described.

A system configuration according to the present embodiment is similar to that illustrated in FIG. 1, so that descriptions are omitted.

### Process Example

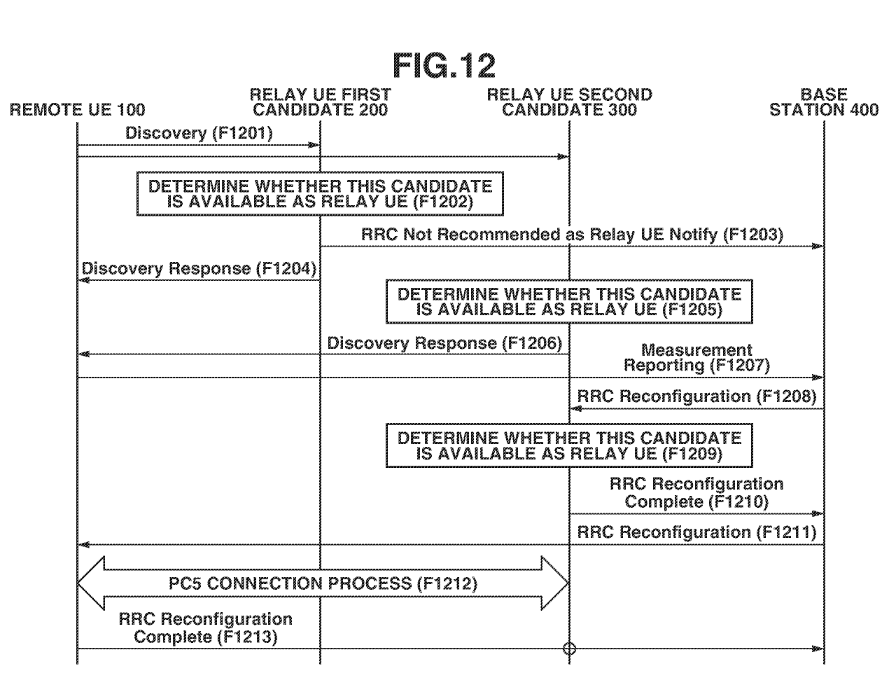

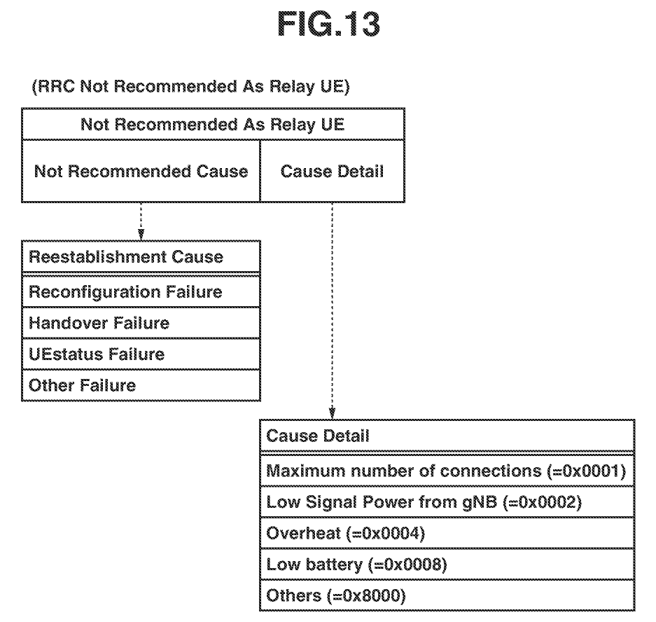

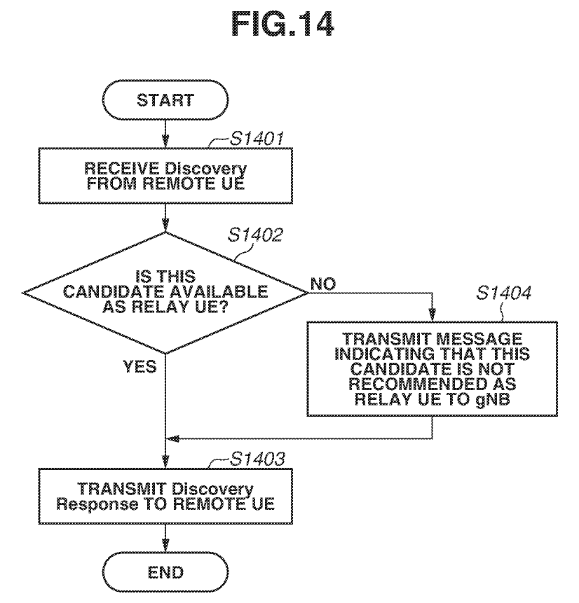

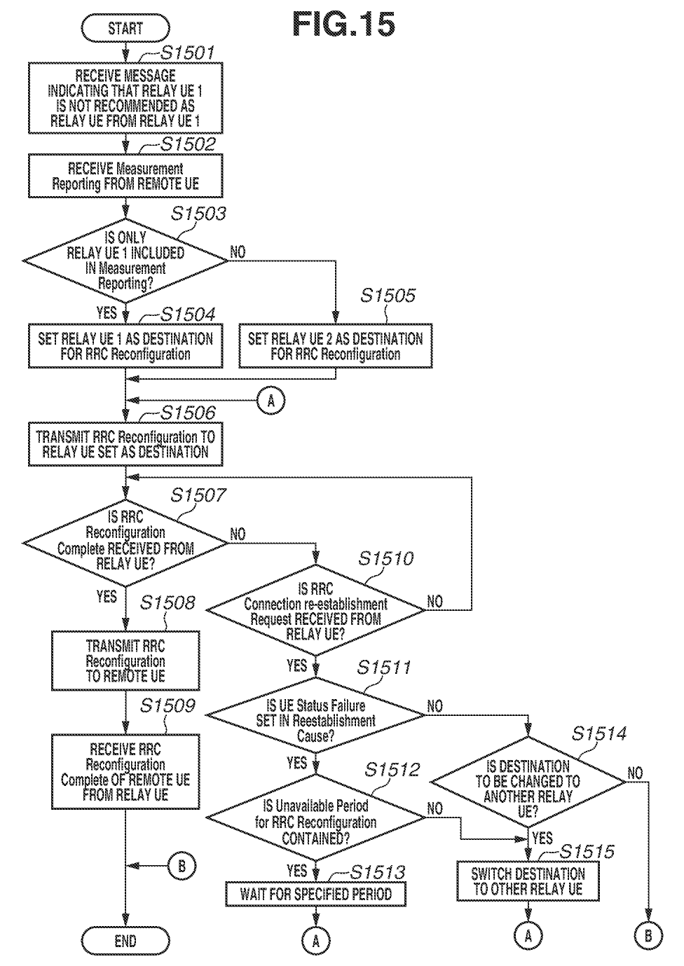

An example of operations according to the present embodiment will be described with reference to an example of an operation sequence illustrated in FIG. 12, an example of a frame structure of an RRC Not Recommended As Relay UE illustrated in FIG. 13, and examples of flowcharts illustrated in FIG. 14 and FIG. 15.

FIG. 12 is a sequence diagram illustrating a case where the availability as relay UE is determined when the relay UE first candidate 200 according to the present embodiment receives a Discovery from the remote UE 100.

The remote UE 100 broadcasts a Discovery via the communication unit 103 to search for a nearby device (F1201). It is determined whether the relay UE first candidate 200 is available as relay UE (F1202). Since details of the process in (F1202) are as in (F306), redundant descriptions are omitted.

FIG. 12 illustrates an example of a sequence in a case where the determination unit 207 is determined as being unavailable as relay UE in (F1202). Subsequently, the determination unit 207 notifies the control unit 201 of the unavailability and the cause of the unavailability. The control unit 201 transmits an RRC Not Recommended As Relay UE to the base station 400 via the communication unit 203 to inform the base station 400 that it is difficult to operate as relay UE, together with the detailed cause information (F1203). A frame structure of the RRC Not Recommended As Relay UE will be described below with reference to FIG. 13. The relay UE first candidate 200 transmits a Discovery response to the remote UE 100 via the communication unit 203 (F1204). The relay UE second candidate 300 determines whether the candidate is available as relay UE (F1205). Since details of the process in (F1202) are as in (F306), redundant descriptions are omitted. In the present embodiment, the determination unit 307 determines that the candidate is available as relay UE in (F1205). The relay UE second candidate 300 transmits a Discovery response to the remote UE 100 via the communication unit 303 (F1206). Since details of the process in (F1207) are as in (F304), redundant descriptions are omitted.

The base station 400 determines the transmission destination of the RRC Reconfiguration based on the relay UE candidate group acquired in (F1207) and the RRC Not Recommended As Relay UE acquired in (F1203). In the present embodiment, the relay UE second candidate 300 is set as the transmission destination.

Since the transmission destination is the only difference, the process from (F1208) to (F1213) differs from the process from (F308) to (F313) only in the transmission destination, so that redundant descriptions are omitted herein.

FIG. 13 is a frame structure illustrating an RRC Not Recommended As Relay UE according to the present embodiment.

This message is newly defined, and an overview of the message will be described prior to the frame structure. The message is used as a notification indicating that the relay UE candidate that is the transmission source is not recommended as relay UE. The message is intended to be transmitted to the base station 400 not as a response to the RRC Reconfiguration but at the time of receiving a Discovery in the present embodiment. In a case where the Measurement Reporting from the remote UE 100 includes the relay UE candidate that is the transmission source of the message, the base station 400 may exclude the relay UE candidate from the RRC Reconfiguration transmission target.

The frame structure will be described. Specifically, the RRC Not Recommended As Relay UE contains Not Recommended Cause information and Cause Detail information. In the Not Recommended Cause, parameters similar to those in the Reestablishment Cause illustrated in FIG. 4 may be set. In the Cause Detail, parameters similar to those in the Cause Detail illustrated in FIG. 4 may be set. It should be noted that although not described in the present embodiment, information referred to as Reserved may be prepared in the Cause Detail, considering future extension.

An example of a frame structure of an RRC Not Recommended As Relay UE according to the present embodiment has been described.

Since details of a flowchart diagram illustrating operations of the remote UE 100 according to the present embodiment is as illustrated in FIG. 5, redundant descriptions are omitted herein.

FIG. 14 is an example of a flowchart diagram illustrating operations of the relay UE first candidate 200 and the relay UE second candidate 300 according to the present embodiment. While only the operations of the relay UE first candidate 200 will be described, the relay UE second candidate 300 can also perform similar operations.

The relay UE first candidate 200 receives a Discovery from the remote UE 100 via the communication unit 203 (S1401). The control unit 201 of the relay UE first candidate 200 notifies the determination unit 207 of an instruction including information necessary for determining whether the candidate is available as relay UE. The determination unit 207 determines whether the candidate is available as relay UE based on the information acquired from the control unit 201 (S1402).

In a case where the determination unit 207 determines that the candidate is available as relay UE (“YES” in S1402), the relay UE first candidate 200 transmits a Discovery response to the remote UE 100 via the communication unit 203 (S1403), as in (S1002). Since details of the subsequent process are as described in (S1003) to (S1013), redundant descriptions are omitted.

In a case where the determination unit 207 determines that the candidate is not available as relay UE (“NO” in S1402), the determination unit 207 notifies the control unit 201 that the candidate is not available as relay UE for the remote UE 100, together with the detailed cause information about the unavailability. The control unit 201 transmits an RRC Not Recommended As Relay UE to the base station 400 via the communication unit 203 (S1404). Subsequently, the processing proceeds to (S1403), and since details of the subsequent process are as described in (S1003) to (S1013), redundant descriptions are omitted.

An example of a flowchart illustrating operations of the relay UE first candidate 200 and the relay UE second candidate 300 according to the present embodiment has been described.

FIG. 15 is an example of a flowchart diagram illustrating operations of the base station 400 according to the present embodiment.

The base station 400 receives an RRC Not Recommended As Relay UE from the relay UE first candidate 200 via the communication unit 403 (S1501). Next, the base station 400 receives a Measurement Reporting from the remote UE 100 (S1502). The control unit 401 checks whether only the relay UE first candidate 200, which is the transmission source of the RRC Not Recommended As Relay UE, is included as a relay UE candidate (S1503). It should be noted that the determination target at this time is the relay UE candidate included in the Measurement Reporting received in (S1502). In a case where only the relay UE first candidate 200 is included, the control unit 401 configures the communication unit 403 to set the relay UE first candidate 200 as the RRC Reconfiguration transmission destination (S1504). In a case where a relay UE candidate other than the relay UE first candidate 200 is also included, the relay UE second candidate 300 is set as the RRC Reconfiguration transmission destination in the present embodiment (S1505). Subsequently, the base station 400 transmits an RRC Reconfiguration to the transmission destination via the communication unit 403 (S1506).

Since details of a process from (S1507) to (S1515) are as in (S703) to (S711), redundant descriptions are omitted herein.

A flowchart illustrating operations of the base station 400 according to the present embodiment has been described.

As described above, according to the present embodiment, in a case where the relay UE first candidate 200 receives a Discovery from the remote UE 100, the determination of whether the UE is available as relay UE is performed based on a factor other than compliance with the RRC Reconfiguration. In addition, the base station 400 is notified that the UE is unavailable as relay UE and is also notified of the cause (detailed cause information) of the unavailability. Thus, even in a case where the relay UE first candidate 200 complies with the RRC Reconfiguration, the relay UE first candidate 200 can be determined as being unavailable as relay UE due to a factor other than the compliance, thereby preventing the relay UE first candidate 200 from operating as relay UE of the remote UE 100. Furthermore, it also becomes possible for the base station 400 to perform processing based on the cause (detailed cause information) of the unavailability of the relay UE first candidate 200.

In the present embodiment, a relay UE candidate that is difficult to operate as relay UE may be excluded from the target before the base station 400 transmits an RRC Reconfiguration. This may expedite the selection of relay UE of the remote UE 100.

Further, the present embodiment produces an effect similar to that produced by the first embodiment. In other words, even in a case where the Cause Detail is a cause other than those described in the present embodiment, or regardless of the presence or absence of the Unavailable Period for RRC Reconfiguration, the effect of the present embodiment does not change.

### Modified Example

Each of the embodiments describes an example of a case where relay UE determines whether the relay UE is available as relay UE based on the apparatus status of the relay UE or the like, and in a case where the relay UE is unavailable, the cause (detailed cause information) of the unavailability is notified to an external apparatus.

In the present modified example, in place of or in addition to the above-described determination, relay UE may be configured to determine whether the relay UE is in a state in which the relay UE prefers not to operate as relay UE unless absolutely necessary, based on the apparatus status of the relay UE or the like.

In the above-described case, the determination unit 207 may use the information that is checked during device connection in the above-described embodiments, such as the number of connections, signal power, battery level, or temperature of its own terminal, as information for determining whether the relay UE is in a state in which the relay UE prefers not to operate unless absolutely necessary. However, the determination unit 207 may use different thresholds to be compared against the information from those used in the above-described embodiments, thereby determining whether the relay UE is in a state in which the relay UE prefers not to operate unless absolutely necessary. Specifically, comparison is performed using a second threshold less strict than each threshold used in the above-described embodiments to determine whether the candidate is available as relay UE. For example, for the number of connections, the second threshold may be set to the upper limit value of the number of connections minus 2, or the like. Further, for the battery level, the second threshold may be set to the lower limit value of the battery level plus 10%. Similarly, for the temperature, signal power, or the like, the second threshold may be set to an upper or lower limit value that is less strict. Specifically, in a case where the number of connections is between the upper limit value of the number of connections and the second threshold of the number of connections, the determination unit 207 determines that the candidate is in a state in which the candidate prefers not to operate unless absolutely necessary. Further, in a case where the battery level is between the lower limit value of the battery level and the second threshold of the battery level, the determination unit 207 determines that the candidate is in a state in which the candidate prefers not to operate unless absolutely necessary. Further, in a case where the current value of the temperature of the battery or the like is between the upper limit value of the temperature and the second threshold less strict than the upper limit value of the temperature, the determination unit 207 determines that the candidate is in a state in which the candidate prefers not to operate unless absolutely necessary. Further, in a case where the current value of the signal power is between the lower limit value of the signal power and the second threshold less strict than the lower limit value of the signal power, the determination unit 207 determines that the candidate is in a state in which the candidate prefers not to operate unless absolutely necessary.

As described above, in a case where the determination unit 207 determines that the candidate is in a state in which the candidate prefers not to operate as relay UE unless absolutely necessary, the relay UE notifies the cause (detailed cause information) to an external apparatus related to the relay UE.

In a case where the first embodiment is combined with the present modified example, the relay UE transmits an RRC Reconfiguration Complete indicating conditional approval (hereinafter, also referred to as “conditionally approved”) to the base station 400, which is an external apparatus. This message includes information indicating that the relay UE has conditionally accepted operating as relay UE, and information indicating the cause, i.e., detailed cause information. The detailed cause information is, for example, information indicating that the upper limit of connections has not been reached but the relay UE has relayed communications from a plurality of devices, information indicating that the battery level may not be sufficient (indicating that the battery level is running low), or the like.

The base station 400 having received the detailed cause information can utilize the detailed cause information as information for reconsidering whether to actually use the relay UE. Further, for example, in a case where the second embodiment is combined with the present modified example, the relay UE may be configured similarly to transmit an RRC Reconfiguration Complete indicating conditional approval to the base station 400, which is an external apparatus. Further, in a case where the second embodiment is configured so that the remote UE is also notified of the cause, the second embodiment can be configured so that a PC5 connection grant indicating conditional approval is transmitted. In this case, the relay UE can include information indicating that the PC5 connection is conditionally granted and detailed cause information indicating the cause in the message, thereby notifying the remote UE of the cause. It should be noted that the action of transmitting the message of conditional approval indicates that the approval is not a simple approval but a conditional approval. In other words, transmitting the message of conditional approval in the present embodiment is understood as transmitting supplemental information indicating that the approval is conditional.

Further, the third embodiment may be combined with the present modified example, for example, as follows. The relay UE may be configured so that in a case where the relay UE determines that the relay UE is in a state in which the relay UE prefers not to operate as relay UE unless absolutely necessary, the relay UE transmits, instead of the message in S1404, a notification of information indicating that its own device (its own terminal) has conditionally accepted operating as relay UE, and detailed cause information indicating the cause. The base station 400 having received the detailed cause information can utilize the detailed cause information as information for determining whether to actually use the relay UE, as needed. Further, the base station 400 having received the detailed cause information can also temporarily utilize the relay UE.

### Other Embodiments

The present disclosure can also be realized by a process in which a program for realizing one or more functions of the above-described embodiments is supplied to a system or an apparatus via a network or a storage medium. One or more processors of a computer of the system or the apparatus read and execute the program. Further, the present disclosure can also be realized by a circuit (e.g., ASIC) configured to realize the one or more functions.

The disclosure is not limited to the above-described embodiments, and various changes and modifications can be made without departing from the spirit and scope of the disclosure. Thus, the claims are attached to disclose the scope of the disclosure.

In the processes, sequences, flowcharts, and the like according to each aspect/embodiment described in the present specification, the order may be changed as long as it does not cause any inconsistency. For example, in the methods described in the present disclosure, various elements of steps are presented using an example order, and the presented specific order is not intended to be limiting.

The information, signals, or the like described in the present disclosure may be output from an upper layer (or a lower layer) to the lower layer (or the upper layer). The information, signals, or the like may be input and output via a plurality of network nodes.

The input information, the output information, and the like may be stored in a specific location (e.g., memory) or managed using a management table. The input information, the output information, and the like may be overwritten, updated, or appended. The output information and the like may be deleted. The input information and the like may be transmitted to another apparatus.

The determinations in the present disclosure may be performed based on a value represented by 1 bit (whether 0 or 1), may be performed based on a Boolean value (Boolean: true or false), or may be performed by comparing numerical values (e.g., by comparing against a predetermined value).

Software may be referred to as software, firmware, middleware, microcode, hardware description language, or any other term. Software should be interpreted broadly to refer to an instruction, instruction set, code, code segment, program code, program, sub-program, software module, function, and the like. Further, software should be interpreted broadly to refer to an application, software application, software package, routine, subroutine, object, executable file, execution thread, procedure, function, and the like.

It should be noted that each term used in the present disclosure and a term necessary for understanding the present disclosure may be replaced with a term having the same or similar meaning.

Further, the information, parameter, or the like described in the present disclosure may be represented using an absolute value, a relative value with respect to a predetermined value, or other corresponding information.

The names used for the above-described parameters are not limited in any respect. Furthermore, a formula or the like using the parameters may differ from that explicitly disclosed in the present disclosure.

Any reference to elements using designations such as “first” and “second” in the present disclosure do not generally limit the amount or order of the elements. The designations may be used as a convenient method for distinguishing two or more elements in the present disclosure. Accordingly, referring to first and second elements does not imply that only two elements may be employed, or that the first element must precede the second element in some form.

The use of the terms “include (include)”, “including (including)”, and other forms in the present disclosure is intended to be inclusive, similarly to the term “comprising (comprising)”. Furthermore, the use of the term “or (or)” used in the present disclosure is not intended to be exclusive OR.

In a case where, for example, articles such as a, an, and the in English are added as a result of translation in the present disclosure, the present disclosure may include plural nouns following the articles.

Each aspect/embodiment described in the present disclosure may be used singly or in combination or may be switched during execution. Further, notification of predetermined information (e.g., notification that “it is X”) is not limited to explicit notification and may be implicit notification (e.g., the predetermined information is not notified).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

The present disclosure makes it possible to provide a system that enables a base station to select suitable relay UE.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A Sidelink relay terminal comprising:
a Discovery reception unit configured to receive a Discovery packet from a Sidelink remote terminal;
a relay request reception unit configured to receive, from a base station, a request to function as a relay terminal;
a first determination unit configured to determine whether the Sidelink relay terminal has a communication capability to accept the request, based on a first parameter related to the communication capability of the Sidelink relay terminal;
a second determination unit configured to determine whether a determination criterion related to a predetermined parameter that is different from the first parameter and managed by the terminal is satisfied;
a communication establishment unit configured to operate as a relay terminal in response to the request in a case where the first determination unit determines that the Sidelink relay terminal has the communication capability to accept the request and the second determination unit determines that the determination criterion is satisfied; and
a notification unit configured to notify the base station of information about availability as a relay terminal that is generated based on the determination criterion.

2. The Sidelink relay terminal according to claim 1, wherein the predetermined parameter relates to a status of the Sidelink relay terminal.

3. The Sidelink relay terminal according to claim 2,
wherein the determination unit operates in a case where the request is received by the relay request reception unit, and
wherein the notification unit notifies, as the information, information indicating at least one of the predetermined parameter having affected the determination result of the determination unit and a value thereof.

4. The Sidelink relay terminal according to claim 2, wherein the predetermined parameter includes at least one of a number of connections with the Sidelink remote terminal, signal power of a signal received from the base station, temperature of the Sidelink relay terminal, and battery level of the Sidelink relay terminal.

5. The Sidelink relay terminal according to claim 2, wherein the information includes a value of the predetermined parameter used by the determination unit and information indicating a relationship with the determination criterion.

6. The Sidelink relay terminal according to claim 4, wherein in a case where the number of connections exceeds a threshold, the determination unit determines that the determination criterion is not satisfied.

7. The Sidelink relay terminal according to claim 4, wherein, in a case where the signal power is less than or equal to a threshold, the determination unit determines that the determination criterion is not satisfied.

8. The Sidelink relay terminal according to claim 4, wherein, in a case where the temperature exceeds a threshold, the determination unit determines that the determination criterion is not satisfied.

9. The Sidelink relay terminal according to claim 4, wherein, in a case where the battery level is less than or equal to a threshold, the determination unit determines that the determination criterion is not satisfied.

10. The Sidelink relay terminal according to claim 1, wherein, in a case where the request is rejected based on the determination result of the second determination unit, the notification unit further notifies period information indicating a period of unavailability as a relay terminal.

11. The Sidelink relay terminal according to claim 1,
wherein the determination unit operates before the request is received by the relay request reception unit, and
wherein the notification unit notifies, as the information, information indicating the determination result of the second determination unit.

12. The Sidelink relay terminal according to claim 1,
wherein the determination criterion includes a first determination criterion and a second determination criterion, the second determination criterion being easier to satisfy than the first determination criterion,
wherein the second determination unit determines the second determination criterion before the request is received by the relay request reception unit, and
wherein the notification unit notifies the information based on the determination result of the determination unit based on the second determination criterion.

13. The Sidelink relay terminal according to claim 12, wherein the information includes information indicating that the request is conditionally approved.

14. A method for controlling a Sidelink relay terminal that is performed by a computer, the method comprising:
receiving a Discovery packet from a Sidelink remote terminal;
receiving, from a base station, a request to function as a relay terminal;
determining, as a first determination, whether the Sidelink relay terminal has a communication capability to accept the request, based on a first parameter related to the communication capability of the Sidelink relay terminal;
determining, as a second determination, whether a determination criterion related to a predetermined parameter that is different from the first parameter and managed by the terminal is satisfied;
operating as a relay terminal in response to the request in a case where the first determination determines that the Sidelink relay terminal has the communication capability to accept the request and the second determination determines that the determination criterion is satisfied; and
notifying the base station of information about availability as a relay terminal that is generated based on the determination criterion.

15. A computer-readable storage medium storing a program of a Sidelink relay terminal that causes a computer to:
receive a Discovery packet from a Sidelink remote terminal;
receive, from a base station, a request to function as a relay terminal;
determine, as a first determination, whether the Sidelink relay terminal has a communication capability to accept the request, based on a first parameter related to the communication capability of the Sidelink relay terminal;
determine, as a second determination, whether a determination criterion related to a predetermined parameter that is different from the first parameter and managed by the terminal is satisfied;
operate as a relay terminal in response to the request in a case where the first determination determines that the Sidelink relay terminal has the communication capability to accept the request and the second determination determines that the determination criterion is satisfied; and
notify the base station of information about availability as a relay terminal that is generated based on the determination criterion.
